(19) United States
(12) Patent Application Publication
(10) Pub. No.: US 2003/0048470 A1
(43) Pub. Date: Mar. 13, 2003

(54) Web browser for network printer

(76) Inventor: Elias S. Garcia, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/949,351

(22) Filed: Sep. 7, 2001

(51) Int. Cl. B41B 1/00; G06F 15/00

(52) U.S. Cl. 358/1.15; 358/1.13; 358/402

(57) ABSTRACT

A printer of the present invention comprises a printing mechanism and a user interface including a web browser. A method of printing of the present invention includes obtaining information using a web browser of the printer and printing that information on the printer.

### THE FIELD OF THE INVENTION

The present invention relates to printers, and in particular, to a web browser for a printer.

### BACKGROUND OF THE INVENTION

In the computer age, almost everyone has either printed out or received a document that was generated by a computer. Printers are found everywhere, usually in close proximity to an associated computer or workstation. Printers conventionally act as appliances to the associated computer or computer network and are generally used only for printing documents stored on the computer.

However, in the last ten years, printers have evolved into multifunction machines that also optionally include many functions such as copying, facsimile transmission, scanning as well as digital sending. While these multifunction printers can operate as stand alone devices for functions such as fax and copying, more advanced features of these multifunction printers, such as sending a scanned document to an electronic mail address, still generally require the printer to interact with an associated computer.

In the meantime, there has been an explosion of information available on the Internet, particularly the World Wide Web. Since most computers users feel compelled to print what they see, printers have been running overtime printing out portions of web pages such as forms, entertainment, etc. as well as printing out downloaded documents and electronic mail messages. Accordingly, in the Internet age, printers do much more than just print out documents generated by a computer workstation.

Despite this evolution of printers and their widespread use, printers remain generally limited to use with an associated computer that controls and/or supports the printer.

### SUMMARY OF THE INVENTION

A printer of the present invention comprises a printing mechanism and a user interface including a web browser. A method of printing of the present invention includes using the web browser of the printer to access information and to direct printing of that information on the printer.

### BRIEF DESCRIPTION OF THE DRAWINGS

FIG. 1 is a perspective view of a printer, according to one embodiment of the present invention.

FIG. 2 is a block diagram of a printing system, according to one embodiment of the present invention.

FIG. 3 is a block diagram of a printer, according to one embodiment of the present invention.

FIG. 4 is a block diagram of a web browser of a printer, according to one embodiment of the present invention.

FIG. 5 is a block diagram of a library web page, according to one embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

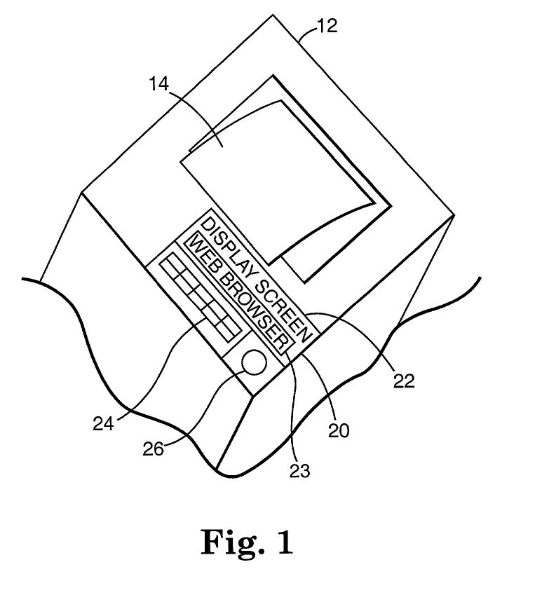

A printer 12 of the present invention is shown generally in FIG. 1 with printed document 14. Printer 12 includes user interface 20 comprising display screen 22 with web browser 23, keypad 24, and pointing device 26. Pointing device 26 preferably comprises any one of a mouse, trackball, touchscreen stylus, or a touchpad as shown in FIG. 1.

User interface 20 facilitates operation of printer 12 for printing documents and for maintaining printer 12. Display screen 22 comprises a video monitor, liquid crystal display, or other well known graphical display system for displaying computer generated graphics. In addition, in combination with pointing device 26, display screen 22 optionally comprises a touchscreen in which contact with the screen surface activates functions of printer 12 and/or associated devices and software programs.

Web browser 23 comprises an Internet browser such as Internet Explorer® or Netscape Navigator®, or other system for generating visual objects such as text, objects, and graphical user interface objects, that can be activated and deactivated with pointing device 26. Web browser 23 preferably further comprises web browser software supported by any one of several computer system platforms such as Windows, Macintosh, Unix, Linux, and other platforms capable of executing web browser software that provides HTTP (Hyper Text Transfer Protocol) client functions and that renders HTML (Hyper Text Markup Language) files.

With Web browser 23 and access to the Internet, printer 12 can access content from web pages of the World Wide Web independent from a computer workstation. Instead, a user at printer 12 can request printing of content from web pages on the World Wide Web via web browser 23. This feature puts the control of printing documents at the printer itself rather than at a computer workstation, which may be located remotely from printer 12.

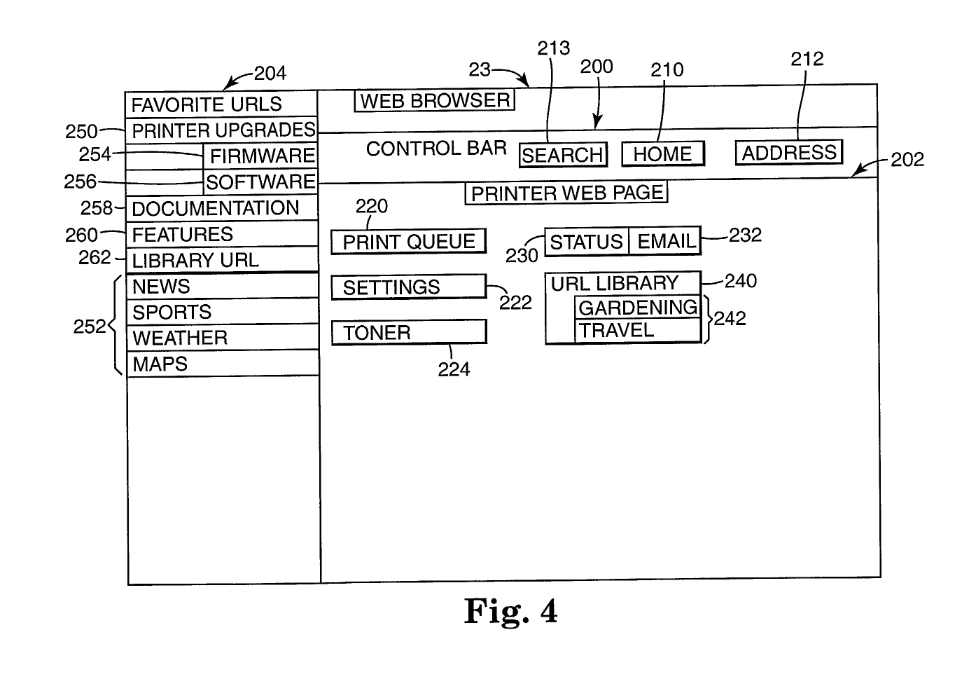

Moreover, with the advent of embedded web servers in appliances such as those disclosed in U.S. Pat. No. 5,596,487, titled EMBEDDING WEB ACCESS MECHANISM IN AN APPLIANCE FOR USER INTERFACE FUNCTIONS INCLUDING A WEB SERVER AND WEB BROWSER, and U.S. Pat. No. 6,107,007, titled EMBEDDING WEB ACCESS FUNCTIONALITY INTO A DEVICE FOR USER INTERFACE FUNCTIONS, web browser 23 can access control features for, and/or information from, virtually any type of electronic device. For example, web browser 23 of printer 12 can access a device web page for a washing machine, copier, fax machine, television, automobile, etc, and print out desired information regarding the device and/or control features of that device. Finally, web browser 23 can even access a device web page of printer 12 for printing stored information on printer 12 and/or for accessing control features of printer 12. This latter feature is described later in greater detail in association with FIG. 4.

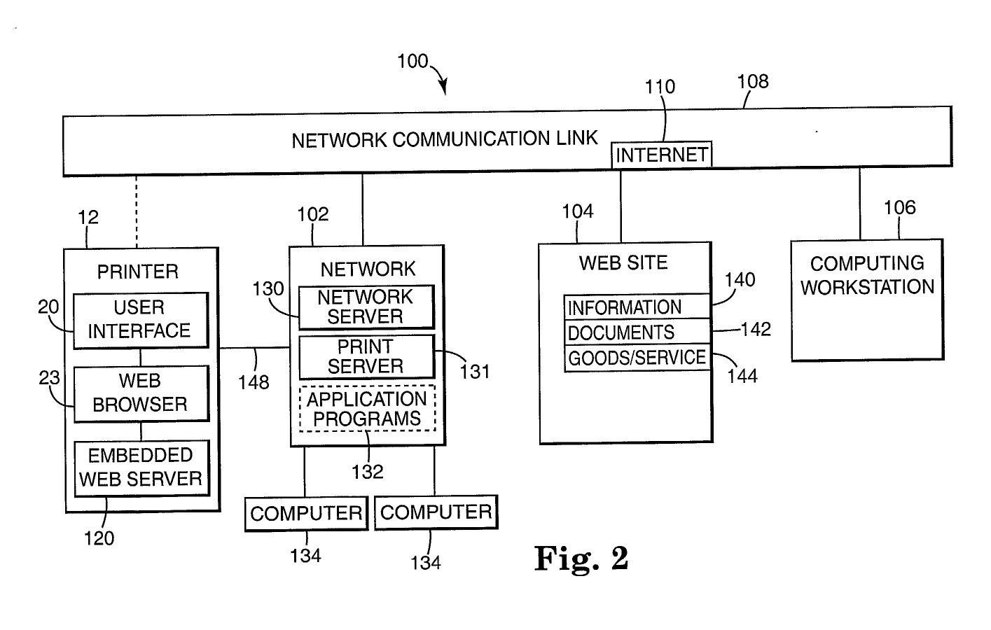

Printer 12 of the present invention also generally comprises a portion of a larger system, such as computing system 100. As shown in FIG. 2, system 100 includes printer 12, network 102, web site 104, computing workstation 106, and network communication link 108. Printer 12 has substantially the same features and functions previously described in association with FIG. 1, including user interface 20 and web browser 23. Printer 12 also further optionally comprises embedded web server 120. Network 102 includes network server 130, print server 131, application programs 132, and computers 134. Web site 104 includes information 140, documents 142, goods/service 144. Network communication link 108 includes Internet link 110.

Network 102 of system 100 comprises a computer network such as client-server network or peer-to-peer network including one or more computers 134 for performing computing tasks and for communication with printer 12. Printer 12 preferably forms a portion of network 102 via link 148 but optionally can communicate with network 102 via network communication link 108. Network 102 can form a home-based network, a local area network, an intranet, or other association of multiple computing devices associated with printer 12. Printer 12 is available for printing documents and other information from computers 134 in network 102. Network server 130 coordinates the use of printer 12 with print server 131 of network 102 and coordinates file handling and communication between computers 134 within network 130. Network server 130 also regulates access of printer 12 to network communication link 108. Application programs 132 comprise any software program running on network 130, such as a word processor, which produces a document for printing by printer 12.

Embedded web server 120 of printer 12 is configured for producing a printer web page 202 (FIG. 4) corresponding to printer 12 so that computers 134 of network 102, computer workstation 106, and even printer 12 itself can use printer web page 202 to monitor and operate the functions of printer 12. Printer web page 202 is described later in greater detail in association with FIG. 4. This embedded web server system is described in U.S. Pat. No. 5,596,487, titled EMBEDDING WEB ACCESS MECHANISM IN AN APPLIANCE FOR USER INTERFACE FUNCTIONS INCLUDING A WEB SERVER AND WEB BROWSER, and U.S. Pat. No. 6,107,007, titled EMBEDDING WEB ACCESS FUNCTIONALITY INTO A DEVICE FOR USER INTERFACE FUNCTIONS, and which are hereby incorporated by reference.

Web site 104 of system 100 provides information 140, documents 142, and/or goods/services 144 through a series of web pages. Web site 104 is accessible through web browser 23 of printer 12, permitting printer 12 to access and print any content available on web site 104.

Network communication link 108, as used herein, includes an Internet communication link (e.g., the Internet), an intranet communication link, or similar high-speed communication link. In one preferred embodiment, network communication link 108 includes an Internet communication link 110. Network communication link 108 permits communication between printer 12, network 102, web site 104, and computing workstation 106.

Using these features of system 100, printer 12 with web browser 23 accesses a web page from web site 104, from printer 12, or from another device such as computer 134 to access a document for printing on printer 12. This function is performed independent of control by an associated computer or computer network, except to the extent that the computer provides a path to network communication link 108 or other communication link to the device having the desired document.

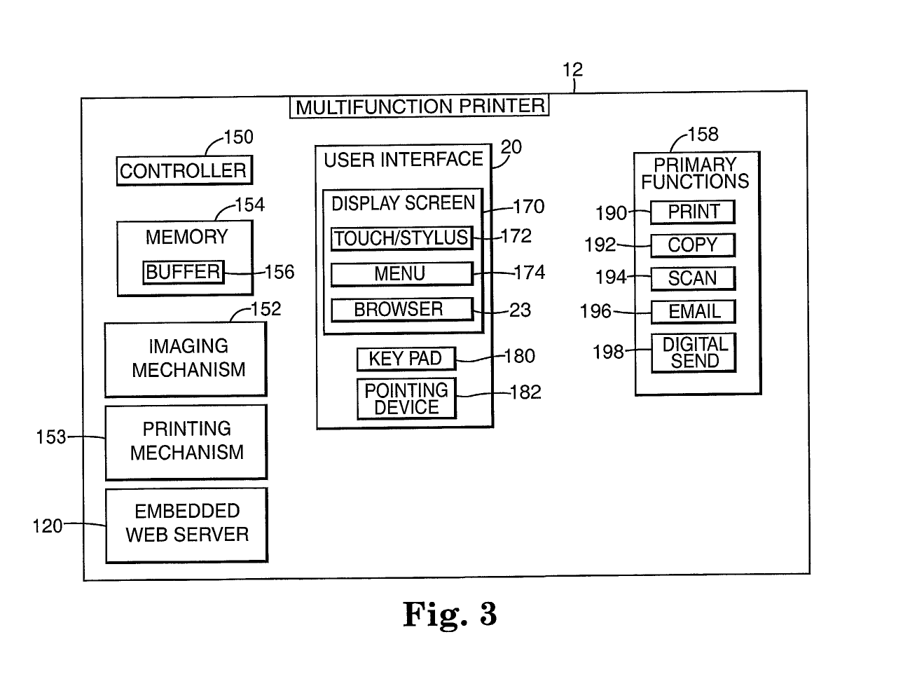

Printer 12 as described in association with FIGS. 1-2 can optionally further comprise a multifunction printer or any device including one or more of a combination of functions such as faxing, copying, scanning, etc. Accordingly, printer 12 is described in greater detail in association with FIG. 3.

As shown in FIG. 3, printer 12 includes user interface 20, controller 150, imaging mechanism 152, printing mechanism 153, and memory 154 with buffer 156. Printer 12 also includes primary functions 158 comprising print function 190, and optionally further including one or more of copy function 192, scan function 194, email function 196, and digital sending function 198. Printer 12 also includes substantially the same features and attributes as previously described for printer 12 in association with FIGS. 1-2.

Controller 150 includes hardware, software, firmware or combination of these. In one preferred embodiment, controller 150 includes a microprocessor based system capable of performing a sequence and logic operations.

Imaging mechanism 152 creates a digital image of a document that is processed by printer 12 during copying, scanning, and/or faxing. Printing mechanism 153 prints that digital image, or a computer generated print file, on paper as a document. Memory 154 stores the digital images of the imaged documents and/or computer generated print files. Buffer 156 of memory 154 holds a copy of the next digital image or print file to be printed.

Primary functions 158 of printer 12 includes functions that are commonly associated with a printer and/or multifunction printer. In particular, print function 190 permits printing documents while copy function 192 permits copying documents. Scan function 194 permits scanning documents to create a digital image of a document while email function 196 permits electronically mailing a scanned document or computer-generated document. Finally, digital sending function 198 permits scanning a document and sending it as an electronic mail message to an electronic mail address without the aid of a personal computer.

Accordingly, any one or all of these functions and features of printer 12, as a stand alone printer or as a multifunction printer, can be used in association with a web browser of the printer, according to the present invention.

An exemplary embodiment of web browser 23 of printer 12 is shown in FIG. 4. Web browser 23 includes control bar 200, printer web page 202, and favorites module 204. Control bar 200 includes home function 210, address function 212, and search function 213. Web page 202 includes print queue 220, settings 222, toner function 224, status function 230 with email option 232, and uniform resource locator (URL) library 240 with topics 242 such as gardening and travel. In addition to these features described in association with FIG. 4, Web browser 23 of printer 12 includes substantially the same attributes and features as described in association with FIGS. 1-3.

Control bar 200 provides the primary functions web browser 23 for navigating the World Wide Web, including back, forward, stop, and refresh, as well as home function 210, address function 212, and search function 213. Activating home function 210 directs web browser 23 to a home page, which in one aspect of the invention, comprises printer web page 202 (associated with printer 12 via embedded web server 120). Address function 212 permits entering an Internet address to which web browser will be directed while search function 213 permits initiating a keyword or natural language search for relevant web sites.

Printer web page 202 provides access to control features of printer 12 such as settings 222 and print queue 220. Print queue 220 of printer web page 202 provides control over initiating and terminating print jobs and indicates the current status and order of documents being printed with printer 12. Toner function 224 indicates the current level of toner in printer 12. Status function 230 indicates the status of printer 12 regarding any alert or error states and includes email option 232 for sending an electronic mail message (i.e., email) to a designated recipient regarding the status of printer 12. URL library 240 comprises a compilation of uniform resource locator addresses corresponding to web pages having information that is generally desirable for printing on printer 12. Uniform resource locator (URL) library 240 includes topics 242 so that anyone looking for printable information on a certain topic (e.g., travel) can select a topic 242 and be directed to uniform resource locators of relevant web pages (e.g., travel related web pages).

Favorites module 204 includes a listing of uniform resource locator addresses for accessing web pages corresponding to a favorite subject listing. Favorites module 204 includes printer upgrade function 250 and common favorite functions 252. Printer upgrade functions 250 includes firmware option 254 and software option 256, documentation function 258, features function 260, and uniform resource locator library upgrade function 262. Common favorites function 252 includes listing of uniform resource locator links to news, sports, etc.

Using web browser 23 of printer 12, as part of user interface 20, a user can navigate the World Wide Web to access and print any selected information or documents from any Web page. For example, web browser 23 can access web page 202 to monitor and control printer 12. In this unique arrangement, web browser 23 of printer 12 permits access to web page 202 of the same printer 12 that supports web browser 23. This arrangement creates a new way to monitor printer 12 with a vast array of flexibly changeable formats and features on web page 202.

In another aspect of the invention, web browser 23 is used to upgrade features of printer 12 and/or to obtain documentation regarding printer 12 for printing on printer 12. For example, by selecting printer upgrade function 252 from favorite module 204 on web browser 23, web browser 23 is directed to a web page of the manufacturer of printer 12 so that the user can download software upgrades to printer 12, including upgrades to web browser 23. At the same web site, using web browser 23, the user can access printable information regarding printer 12 and direct printing of that information on printer 12. Similarly, web browser 23 can be directed more information at another web site using documentation favorite function 258 for obtaining printable information for printing at printer 12.

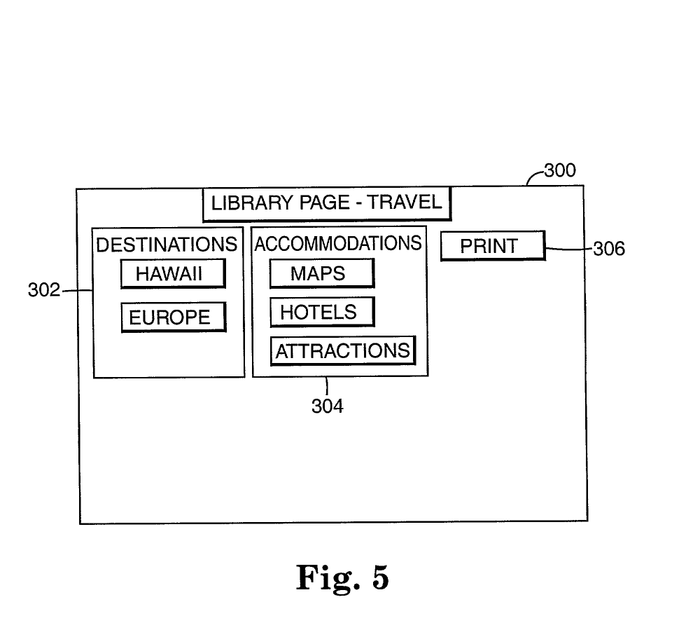

To make use of web browser 23 of printer 12 particularly convenient, uniform resource locator (URL) library 240 (FIG. 4) contains preselected topics 242, such as gardening and travel, for quickly accessing a relevant web page for printable content. For example, URL library 240 preferably contains links to web pages such as library page 300, as shown in FIG. 5. Library page 300 includes destination function 302 such as Hawaii and Europe, accommodations function 304 including maps, hotels and attractions, and print function 306. Activating any one of these functions 302-306 yields either a web page with the corresponding desired information. URL library 240 can be upgraded by activating URL library upgrade function 262, which directs web browser 23 to a web page that downloads library upgrades.

In the same way that printer 12 produces web page 202 (using embedded web server 120) for optionally controlling printer 12, a computer, such as computer workstation 106 or computer 134, or other computer-related device can include an embedded web server that provides an associated computer web page. With this arrangement, printer 12 with web browser 23 can access a document on that computer via the computer web page to print documents from that computer on printer 12. The computer web page limits access of web browser 23 of printer 12 to only certain documents within the computer to protect the remaining contents of the computer. In other words, web browser 23 of printer 12 of the present invention permits back door-initiated printing of documents from a computer where the printing is initiated from printer 12 instead of being initiated from computer.

A method and system of the present invention for a web browser of a printer includes several advantageous features. Foremost, with a method and system of the present invention, a user can access documents through the World Wide Web using a web browser of a printer and print that document on the same printer. This convenient procedure is accomplished independent of a computer workstation that is conventionally directly associated with the operation of a printer. Moreover, when the printer is equipped with an embedded web server, this printer web browser can even be used to access the web page associated with the printer to operate the printer.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A printer comprising:
a printing mechanism; and
a user interface including a web browser.

2. The printer of claim 1 wherein the user interface further comprises:
a display screen; and
a pointing device.

3. The printer of claim 1 and further comprising:
an embedded web server configured to produce a web page associated with the printer for controlling the printer with the web page being configured for access by the web browser of the printer.

4. A printing system comprising:
a printer including a web browser; and
a computing network including a network server configured to support the printer and to provide access for the web browser to the World Wide Web.

5. The printing system of claim 4 wherein the network server of the computing network includes application programs configured to perform tasks and to be operable through the web browser of printer.

6. A printer web browser comprising:
a graphical user interface including:
printer-related upgrade functions configured for updating through the internet including at least one of a firmware or software-based printer function, a documentation, and a uniform resource locator library of the printer.

7. The printer web browser of claim 6 comprising:
a status monitor configured to report a status of the printer using electronic mail.

8. The printer web browser of claim 6 wherein the uniform resource locator library comprises a compilation of information-based uniform resource locator addresses for accessing web pages with content suitable for printing on a printer associated with the printer web browser.

9. A method of upgrading a printer comprising:
establishing a link between a printer support web site and a web browser of a printer; and
using the web browser of the printer to download from the web site a printer software function of the printer.

10. The method of claim 9 and further comprising:
installing, with the web browser, the printer software function in the printer.

11. A method of printing web pages comprising:
accessing a web page using a web browser of a printer; and
printing the web page using the printer.

12. The method of claim 11 and further comprising:
providing a library of uniform resource locators for web pages available through the web browser of the printer.

13. A method of sending information comprising:
accessing a web page using a web browser of a printer; and
sending, at least one of a printable portion of a web page and a document from a web page, to at least one of facsimile machine, an external printer, an electronic mail address, and a digital sender.

14. A method of printing a document comprising:
accessing, with a web browser of a printer, a document on a computer through a web page generated by an embedded web server of the computer; and
directing, with the web browser of the printer, printing of the document on the printer.

15. A method of printing information comprising:
obtaining information externally from a printer using a web browser of the printer; and
printing that information on the printer.

16. The method of claim 15 wherein obtaining information comprises accessing a web page using the web browser of the printer.

17. A computer-readable medium having computer-executable instructions for performing a method of upgrading a printer, the method comprising:
establishing a link between a printer support web site and a web browser of a printer; and
using the web browser of the printer to download from the web site a printer software function of the printer.

18. A computer-readable medium having computer-executable instructions for performing a method of printing web pages, the method comprising:
accessing a web page using a web browser of a printer; and
printing the web page using the printer.

19. A computer-readable medium having computer-executable instructions for performing a method of sending information, the method comprising:
accessing a web page using a web browser of a printer; and
sending, at least one of a printable portion of a web page and a document from a web page, to at least one of facsimile machine, an external printer, an electronic mail address, and a digital sender.

20. A computer-readable medium having computer-executable instructions for performing a method of printing a document, the method comprising:
accessing, with a web browser of a printer, a document on a computer through a web page generated by an embedded web server of the computer; and
directing, with the web browser of the printer, printing the document on the printer.
